(19) United States
(12) Patent Application Publication
(10) Pub. No.: US 2011/0003146 A1
(43) Pub. Date: Jan. 6, 2011

(54) ADHESIVE AND ITS APPLICATION

(75) Inventors: Jianlin Qiu, Guangzhou (CN); Hui Zhang, Guangzhou (CN)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/845,146

(22) Filed: Jul. 28, 2010

Related U.S. Application Data
(63) Continuation of application No. PCT/CN2009/000119, filed on Feb. 1, 2009.

(30) Foreign Application Priority Data
Jan. 28, 2008 (CN) 200810003891.0

(51) Int. Cl. B32B 7/12; C08G 18/71; C09J 7/02

(52) U.S. Cl. 428/355 N; 528/69

(57) ABSTRACT

The invention provides a tri-component adhesive composition comprising a first component containing one or more polyols, a second component containing one or more isocyanates and a third component containing one or more all-purpose polyurethane catalysts or modified catalysts thereof. According to different applications, the additive proportion of the third component is adjusted to achieve desired curing speed and adhesive strength of the adhesive under a wide range of temperature.

### FIELD OF THE INVENTION

The present invention relates to an adhesive composition, particularly relates to a tri-component polyurethane adhesive composition which performances, such as curing speed, adhesive strength, can be conveniently adjusted under a very wide range of temperature.

### BACKGROUND OF THE INVENTION

The composition of a existing single component adhesive is commonly isocyanate terminated prepolymers; while the composition of a two component adhesive is commonly that: component A is a polyol resin mixture, comprising polyester polyols and polyether polyols etc.; component B is a curing agent comprising isocyanates, such as TDI, MDI and their derivatives, which additive proportion is 15-50% of component A. To ensure the curing speed and adhesive strength of the adhesive, the component A will vary depending on different environmental temperature. Uncertain factors may be brought in the process of production, transport, spreading and curing etc. At the same time, the above two adhesives are only suitable for operating in a certain temperature range in general due to their changeless components. When the temperature is changed, the curing speed, the performances of cured material and adherend will be largely affected adversely.

Therefore, there exists a need for adhesive composition conveniently useful under different environmental temperatures. The invention addresses the above problems.

### DESCRIPTION OF THE INVENTION

The invention provides a tri-component adhesive having better stability and longer storage time and conveniently usable under a very wide environmental range, and a method of producing formed adhesive article by the tri-component adhesive under different temperatures.

The above objects may be achieved by adding new additive (a third component), i.e. keeping the raw materials of the previous two components unchanged and adding the additive in different proportions according to different temperatures to solve the above temperature problems. The third component contains all-purpose polyurethane curing catalyst, and can facilitate curing speed and adhesive strength of the adhesive by adjusting additive proportion under different temperatures.

In one embodiment, the invention provides a tri-component polyurethane adhesive composition, which comprises a first component (component A) containing one or more polyols; a second component (component B) containing one or more isocyanates and a third component (component C) containing one or more catalysts or modified catalysts thereof. Optionally, other components may also be added, such as chain extenders, fillers, fibers, plasticizers, pigments, colorants, flame retardants, fungicides, dispersing aids, thixotropic agents, tackifiers or internal lubricants.

In the adhesive composition of the invention, polyols may comprise in the range of about 20 weight percent to about 70 weight percent of the all adhesive composition.

In the adhesive composition of the invention, the mole ratio of —NCO group of the isocyanates component to —OH group of the polyols is about 0.9 to 1.3. Preferably, the mole ratio of —NCO group of the isocyanates component to —OH group of the polyols is about 1 to 1.2. More preferably, in a tri-component adhesive composition of the invention, the mole ratio of —NCO group of the isocyanate component to —OH group of the polyols is about 1.05 to 1.15. Most preferably, the mole ratio of the isocyanate component to the polyol component is about 1.1:1.

In the adhesive composition of the invention, the third component comprises in the range of about 0.001 weight percent to about 10 weight percent of the adhesive.

In one aspect, component A contains polyol resins or mixtures thereof, including polyester polyols, polyether polyols or the combination thereof; component B contains isocyanate curing agents, including TDI (toluene diisocyanate), MDI (diphenylmethane diisocyanate), their derivatives, or the combinations thereof, which additive proportion is about 15-50% of component A by weight. Component C contains all-purpose polyurethane curing catalysts or modified catalysts thereof, which additive proportion is about 0.01-2% of component A by weight. Preferably, the additive proportion of component C is about 0.5-2% of component A by weight; still more preferably, about 0.75-1.5%.

In one embodiment, the invention provides a method using a tri-component adhesive under different temperatures. The tri-component adhesive comprises a first component containing one or more polyols, a second component containing one or more isocyanates and a third component containing one or more catalysts or modified catalysts thereof. The method comprises the steps of: keeping the composition of the first component and the second component constant; adjusting the amount of the third component according to different temperature ranges, wherein the amount of the third component is sufficient to achieve desired curing speed and adhesive strength under the corresponding temperature; and mixing the three components. In general, with the decrease of temperature, the additive amount of the third component will be increased.

In one aspect of this embodiment, the third component comprises in the range of about 0.001-0.5 weight percent of the adhesive when the temperature is in the range of 25-40° C.; the third component comprises in the range of about 0.5-10 weight percent of the adhesive when the temperature is in the range of 5-25° C.

In one embodiment, the invention provides a catalyst additive used to improve the performance of an adhesive under different temperature. In one aspect, the adhesive is a tri-component adhesive, wherein the third component comprises the catalyst, which is added in an efficient amount depending on environmental temperature. In one aspect, the composition of a first component and a second component remains unchanged. In further aspect, the catalyst is selected from a group consisting of tin compound catalyst, organometallic catalyst, amine catalyst or the combinations thereof, wherein the catalyst may comprise in the range of about 0.001 weight percent to about 10 weight percent of the adhesive. In further aspect of this embodiment, the catalyst comprises in the range of about 0.001-0.5 weight percent of the adhesive when the temperature is in the range of 25-40° C.; the catalyst comprises in the range of about 0.5-10 weight percent of the adhesive when the temperature is in the range of 5-25° C.

In one embodiment, the invention provides the use of the tri-component adhesive of the invention in the bonding of substrates. In one aspect, according to different application temperature, the third component of the invention is added in a corresponding amount which is sufficient to achieve desired curing speed and adhesive strength under a corresponding temperature; the three components are mixed; and the obtained tri-component adhesive is applied on the substrate. The substrate includes, but is not limited to, various wood, glass, stone, metal sheet, leather and plastic substrate material such as PVC etc.

In another embodiment, the invention provides a method to improve the performance of adhesive under different temperature, including adding an efficient amount of the adhesive according to the applied environmental temperature of the adhesive so that the adhesive has desired performance under the environmental temperature. In one aspect, the adhesive is a tri-component adhesive, wherein a third component including the catalyst, is added in an efficient amount according to the applied environmental temperature. In one aspect, the composition of a first component and a second component remains unchanged.

In this embodiment, the catalyst is selected from a group consisting of tin compound catalyst, organometallic catalyst, amine catalyst or the combinations thereof, wherein the catalyst may comprise in the range of about 0.001 weight percent to about 10 weight percent of the adhesive.

In one aspect of this embodiment, the catalyst comprises in the range of about 0.001-0.5 weight percent of the adhesive when the environmental temperature is in the range of 25-40° C.; the catalyst comprises in the range of about 0.5-10 weight percent of the adhesive when the environmental temperature is in the range of 5-25° C.

In one embodiment, the invention provides a method to improve conventional two component adhesive, characterized by keeping the composition of a first component and a second component unchanged, and adding a catalyst additive as a third component in an efficient amount according to the environmental temperature when used. In further aspect, the catalyst is selected from a group consisting of tin compound catalyst, organometallic catalyst, amine catalyst or the combinations thereof, in which the catalyst may comprise in the range of about 0.001 weight percent to about 10 weight percent of the adhesive. In further aspect of this embodiment, the catalyst comprises in the range of about 0.001-0.5 weight percent of the adhesive when the environmental temperature is in the range of 25-40° C.; the catalyst comprises in the range of about 0.5-10 weight percent of the adhesive when the environmental temperature is in the range of 5-25° C.

In one embodiment, the invention provides an article made by using the tri-component adhesive of the invention.

In various embodiments, the invention provides the following technical solutions:

1. A tri-component adhesive composition comprising:

a first component containing one or more polyols;

a second component containing one or more isocyanates; and

a third component containing one or more catalysts.

2. The tri-component adhesive composition of technical solution 1, wherein the polyols have a hydroxyl functionality of at least two and molecular weights in the range of about 400 to about 5000.

3. The tri-component adhesive composition of technical solution 2, wherein the polyols are selected from the group consisting of polyether polyols, polyester polyols, polyolefin polyols, polycarbonate polyols and mixtures thereof.

4. The tri-component adhesive composition of technical solution 3, wherein the polyols are selected from the group consisting of polyhydroxy ethers, polyhydroxy polyesters, ethylene or propylene oxide adducts of polyols and monosubstituted esters of glycerol, polybutadiene diol, polyisobutylene diol, polycaprolactone diol, polycarbonate diol and mixtures thereof.

5. The tri-component adhesive composition of technical solution 4, wherein the polyhydroxy ethers include substituted or unsubstituted polyalkylene ether glycols or polyhydroxy polyalkylene ethers.

6. The tri-component adhesive composition of technical solution 3, wherein the polyether polyols include linear and/or branched polyethers having hydroxyl groups.

7. The tri-component adhesive composition of technical solution 6, wherein the polyether polyols are selected from the group consisting of polyoxyalkylene polyol, its homopolymer and copolymer and oligomer polyols.

8. The tri-component adhesive composition of technical solution 7, wherein the polyoxyalkylene polyols include polyethylene glycol, polypropylene glycol, polybutylene glycol, polyoxypropylene diol, polyoxypropylene triol or polytetrahydrofuran glycol; the oligomer polyols include polybutadiene glycol or polybutadiene-co-acrylonitrile glycol.

9. The tri-component adhesive composition of technical solution 3, wherein the polyester polyols include unsaturated polyester polyols having at least one ethylenically unsaturated group per molecule and predominantly hydroxyl end groups.

10. The tri-component adhesive composition of technical solution 3, wherein the polyester polyols include polyethylene glycol adipate diol, polyethylene-propylene glycol adipate diol, polydiethylene glycol adipate diol, polyethylene-diethylene glycol adipate diol, poly-1,4-butanediol adipate diol, polyneopentylglycol-1,6-hexanediol adipate diol and the like or the combinations thereof.

11. The tri-component adhesive composition of any one of technical solutions 1-10, wherein the polyols comprise in the range of about 20 weight percent to about 70 weight percent of the all adhesive.

12. The tri-component adhesive composition of technical solution 1, wherein the isocyanates comprises polymeric isocyanate, monomeric isocyanate, prepolymeric isocyanateand or the combinations thereof.

13. The tri-component adhesive composition of technical solution 12, wherein the isocyanates include ethylene diisocyanate; 1,4-tetramethylene diisocyanate; 1,4 and/or 1,6-hexamethylene diisocyanate; 1,12-dodecane diisocyanate; cyclobutane-1,3-diisocyanate; cyclohexane-1,3- and 1,4-diisocyanate and mixtures of these isomers; 1-isocyanato-3,3,5-trimethyl-5-isocyanatomethyl cyclohexane; 2,4- and 2,6-hexahydrotolylene diisocyanate and mixtures of these isomers; hexahydro-1,3- and/or 1,4-phenylene diisocyanate; perhydro-2,4′- and/or 4,4′-diphenyl methane diisocyanate; 1,3- and 1,4-phenylene diisocyanate; 2,4- and 2,6-toluene diisocyanate and mixtures of these isomers; diphenyl methane-2,4′- and/or 4,4′-diisocyanate; naphthylene-1,5-diisocyanate; 1,3- and 1,4-xylylene diisocyanate, 4,4′-methylene-bis(cyclohexyl isocyanate), 4,4′-isopropyl-bis(cyclohexyl isocyanate), 1,4-cyclohexyl diisocyanate and 3-isocyanatomethyl-3,5,5-trimethylcyclohexyl isocyanate (IPDI); 2,4- and 2,6-toluene diisocyanate; diphenylmethane diisocyanate; hexamethylene diisocyanate; dicyclohexylmethane diisocyanate; isophorone diisocyanate; 1-methyoxy-2,4-phenylene diisocyanate; 1-chlorophenyl-2,4-diisocyanate; p-(1-isocyanatoethyl)-phenyl isocyanate; m-(3-isocyanatobutyl)-phenyl isocyanate and 4-(2-isocyanate-cyclohexyl-methyl)-phenyl isocyanate, isophorone diisocyanate, toluene diisocyanate and mixtures thereof.

14. The tri-component adhesive composition of technical solution 12, wherein the isocyanates include aliphatic or aromatic diisocyanates.

15. The tri-component adhesive composition of technical solution 14, wherein the aliphatic or aromatic diisocyanates are obtained by reacting excess diisocyanate with polyfunctional compounds containing hydroxyl or amine groups.

16. The tri-component adhesive composition of any one of technical solutions 1-15, wherein the mole ratio of the —NCO group of the isocyanates to —OH group of the polyols is about 0.9 to 1.3.

17. The tri-component adhesive composition of technical solution 16, wherein the mole ratio of the —NCO group of the isocyanates to —OH group of the polyols is about 1 to 1.2.

18. The tri-component adhesive composition of technical solution 17, wherein the mole ratio of the —NCO group of the isocyanates to —OH group of the polyols is about 1.05 to 1.15.

19. The tri-component adhesive composition of any one of technical solutions 1-15, wherein the mole ratio of the isocyanates component to the polyols component is about 1.1:1.

20. The tri-component adhesive composition of any one of technical solutions 1-15, wherein the second component is about 15-50% of the first component by weight.

21. The tri-component adhesive composition of any one of technical solutions 1-20, wherein the catalysts comprise all-purpose polyurethane catalysts or modified catalysts thereof.

22. The tri-component adhesive composition of technical solution 21, wherein the catalysts are selected from a group consisting of tin compound catalyst, organometallic catalyst, amine catalyst or the combinations thereof.

23. The tri-component adhesive composition of technical solution 22, wherein the tin compound catalysts include stannous salts of carboxylic acids, butyistannonic acids, organothiostannonic acids, diorganotin oxides, diorganotin sulfides, mono- and diorganotin halides, mono- and diorganotin carboxylates, mono- and diorganotin mercaptides, mono- and diorganotin derivatives of mercaptocarboxylic acid esters and mercaptoalkanol esters, diorganotin oxides and mono- and diorganotin derivatives of beta-diketones.

24. The tri-component adhesive composition of technical solution 23, wherein the tin compound catalyst is dibutyltin dilaurate.

25. The tri-component adhesive composition of technical solution 22, wherein the organometallic catalysts include organometallic compounds of iron, bismuth, zirconium, titanate, zinc and cobalt.

26. The tri-component adhesive composition of technical solution 22, wherein the amine catalysts include aliphatic polyamine, polymethylene diamine, aliphatic amine with high carbon number, aliphatic amine with aromatic ring, aromatic amines, cycloaliphatic amine and heterocyclic amine.

27. The tri-component adhesive composition of technical solution 26, wherein the amine catalysts are selected from the group consisting of diethylenetriamine, diethylenetetraamine and the modifier thereof, meta-dimethylphenylene diamine and the modifier thereof, N,N-dimethylaminoethanol, tris(dimethyl aminopropyl) amine, N,N-dimethylcyclohexylamine, bis-(2-methyl aminoethyl) ether, N,N-dimethylbenzylamine, diaminobicyclooctane, triethylamine, tributylamine, N-methylmorpholine, N-ethyl-morpholine, N-coco-morpholine, N,N,N′,N″-tetramethyl-ethylene-diamine, 1,4-diaza-bicyclo-(2,2,2)-octane, N-methyl-N′-dimethyl-amino-ethylpiperazine, N,N-dimethyfbenzylamine, bis-(N,N-diethyl-aminoethyl)adipate, N,N-diethylbenzylamine, pentamethyl-diethylenetriamine, N,N-dimethyl-cyclohexylamine, N,N,N′,N′-tetramethyl-1,3-butanediamine, N,N-dimethyl-beta-phenyiethylamine, 1,2-dimethyl-imidazole, 2-methy limidazole and mixtures thereof.

27. The tri-component adhesive composition of technical solution 26, wherein the amine catalysts are selected from the group consisting of tertiary amine or mannich base.

28. The tri-component adhesive composition of technical solution 27, wherein the amine catalysts are selected from a group consisting of 2,2,4-trimethyl-2-silamorpholine and 1,3-diethyamino-ethyltetramethyl-disiloxane.

29. The tri-component adhesive composition of any one of technical solutions 1-28, wherein the third component comprises in the range of about 0.001 weight percent to about 10 weight percent of the adhesive.

30. The tri-component adhesive composition of technical solution 29, wherein the third component comprises in the range of about 0.001-0.5 weight percent of the adhesive when the environmental temperature is in the range of 25-40° C.; the third component comprises in the range of about 0.5-10 weight percent of the adhesive when the environmental temperature is in the range of 5-25° C.

31. The tri-component adhesive composition of any one of technical solutions 1-28, wherein the third component is about 0.01-2% of the first component by weight.

32. The tri-component adhesive composition of technical solution 31, wherein the third component is about 0.5-2% of the first component by weight.

33. The tri-component adhesive composition of technical solution 32, wherein the third component is about 0.75-1.5% of the first component by weight.

34. The tri-component adhesive composition of any one of technical solutions 1-33, optionally including chain extenders, fillers, fibers, plasticizers, pigments, colorants, flame retardants, fungicides, dispersing aids, thixotropic agents, tackifiers or internal lubricants.

35. The tri-component adhesive composition of technical solution 34, wherein the chain extenders are selected from the group consisting of ethylene glycol, propylene glycol, 1,4-butanediol, 2,3-butanediol, diethylene glycol, 1,6-hexane diol, trimethyol propane, glycerol, sorbitol, hydroxyl-terminated polyethylene oxide (polyethylene glycol), glycerin and mixtures thereof.

36. The tri-component adhesive composition of technical solution 35, wherein the chain extender comprises in the range of about 0 weight percent to about 20 weight percent of the adhesive.

37. The tri-component adhesive composition of any one of technical solutions 1-36, further comprises illustrative materials, which record the corresponding amount of the third component used in different temperature range.

38. The tri-component adhesive composition of technical solution 37, the form of the illustrative materials is selected from the group consisting of recording paper, CD, DVD, tape and video tape.

39. A method for using the tri-component adhesive of any one of technical solution 1-38 under different temperature, comprising the steps of: keeping the composition of the first component and the second component unchanged; adjusting the amount of the third component according to different temperature, which is sufficient to achieve desired performance under the temperature; and mixing the three components.

40. The method of technical solution 39, wherein the third component comprises in the range of about 0.001-0.5 weight percent of the adhesive when the temperature is in the range of 25-40° C.; the third component comprises in the range of about 0.5-10 weight percent of the adhesive when the temperature is in the range of 5-25° C.

41. Use of the tri-component adhesive composition of any one of technical solutions 1-38 in the bonding of wood floor.

42. An article, obtained by applying the tri-component adhesive of any one of technical solutions 1-38 to a substrate.

43. The article of technical solution 42, wherein the substrate is wood, glass, stone, metal sheet, leather and PVC plastic substrate.

44. The article of technical solution 43, wherein the wood is beech wood.

45. A method to improve the performance of adhesive under different temperature, comprising adding an efficient amount of catalyst according to the environmental temperature applied by the adhesive so that the adhesive has the desired performance under the temperature.

46. The method of technical solution 45, wherein the adhesive is a tri-component adhesive comprising the catalyst added in an efficient amount according to environmental temperature when used.

47. The method of technical solution 46, wherein the composition of the first component and the second component of the tri-component adhesive remains unchanged.

48. The method of any one of technical solutions 45-47, wherein the catalysts are selected from the group consisting of tin compound catalyst, organometallic catalyst, amine catalyst or the combinations thereof.

49. The method of any one of technical solutions 45-48, wherein the catalyst comprises in the range of about 0.001 weight percent to about 10 weight percent of the adhesive.

50. The method of technical solution 49, wherein the third component comprises in the range of about 0.001-0.5 weight percent of the adhesive when the environmental temperature is in the range of 25-40° C.; the third component comprises in the range of about 0.5-10 weight percent of the adhesive when the environmental temperature is in the range of 5-25° C.

Besides component A and B similar to those in a two component adhesive, the tri-component polyurethane adhesive of the invention also contains component C, which contains all-purpose polyurethane curing catalyst or the modified type thereof. The adding of component C can decrease the actual pressing time so as to provide many advantages of processing and performance. Compared with a single component adhesive, the tri-component adhesive has better storage stability and longer storage time. Related to a two component adhesive, the tri-component adhesive can adjust the curing speed of adhesive conveniently to meet user's operating need in various areas, since the tri-component adhesive has a particular component C and can adjust the additive proportion of component C according to different temperature to facilitate curing speed and adhesive strength of the adhesive.

### DETAILED DESCRIPTION OF THE EMBODIMENTS

Unless defined otherwise herein, all technical and scientific terms used herein have the same meaning as commonly understood by one of ordinary skill in the art to which this invention pertains. Although any methods and materials similar or equivalent to those described herein find use in the practice of the present invention, preferred methods and materials are described herein. In addition, as used herein, the terms “a”, “an” or “the” include the plural, unless the context clearly indicates otherwise. The scope of number includes the number defining the scope. Subtitles of the invention are only used for purposes of illustration only, not intended to limit the scope of the invention.

1. Definitions

As used herein, the term “polyurethane adhesive” refers to the adhesive having carbamate group (NHCOO—) and isocyanate group (NCO—) in the main chain. In general, the polyurethane adhesive may be divided into single component, two component or multi component polyurethane adhesive by package.

As used herein, the term “curing agent” means a substance which can change monomer or oligomer to linear or reticular high polymer. The curing agent is also called hardening agent or maturing agent; in some case, called crosslinking agent or vulcanizing agent. The curing agent may be selected according to the type of main material in the adhesive, the requirement for the performance of the bonding member, specific process methods, environmental protective problems and the like.

As used herein, the term “all-purpose polyurethane curing catalysts” refers to any catalyst which can accelerate the reactive speed between —OH group and —NCO group.

2. Description of the invention

The present invention relates to a tri-component polyurethane adhesive composition, comprising a first component (component A) containing one or more polyols; a second component (component B) containing one or more isocyanates and a third component (component C) containing one or more catalysts or modified catalysts thereof. The additive proportion of component B is about 15-50% of component A by weight. For example, the mole ratio of the isocyanates component to the polyols component is about 1.1:1. Component C may comprise in the range of about 0.001 weight percent to about 10 weight percent of the adhesive. For example, the additive proportion of component C is about 0.01-2% of component A by weight; preferably, about 0.5-2% of component A by weight; still more preferably, about 0.75-1.5%.

Optionally, other components may also be added into the tri-component adhesive of the invention, such as chain extenders, fillers, fibers, plasticizers, pigments, colorants, flame retardants, fungicides, dispersing aids, thixotropic agents, tackifiers or internal lubricants.

The tri-component adhesive of the invention comprises polyols component, isocyanates component and catalyst component. In order to obtain a completely cured system, the mole ratio of —NCO group of the isocyanates component to —OH group of the polyols is about 0.9 to 1.3; preferably, about 1 to 1.2; more preferably, about 1.05 to 1.15; most preferably, about 1.1:1. Slightly excessive isocyanates ensure the complete reaction of polyols. Excessive isocyanates may finally become one part of the system by reacting with moisture in atmosphere or substrate.

In further embodiments, the tri-component adhesive composition of the invention further comprises illustrative material, which record the corresponding amount of the third component used in different temperature range.

Polyols Component

Component A of the adhesive composition, polyols component, may contain one or more polyols. Preferably, the polyols to be used have a hydroxyl functionality of at least two and molecular weights in the range of about 400 to about 5000, and comprise polyether polyols, polyester polyols, polyolefin polyols, polycarbonate polyols and mixtures thereof. The polyols which may be used comprise polyhydroxy ethers (substituted or unsubstituted polyalkylene ether glycols or polyhydroxy polyalkylene ethers), polyhydroxy polyesters, the ethylene or propylene oxide adducts of polyols and the monosubstituted esters of glycerol, polybutadiene diol, polyisobutylene diol, polycarbonatel as well as mixtures thereof. “Polymer polyols” are also suitable, i.e., graft polyols containing a proportion of a vinyl monomer, polymerized in situ, such as Niax 34-28, commercially available from Dow Chemical Company. Additional polyols include polycaprolactone diols and polycarbonate diols. The polyol is typically used in an amount of between about 25 weight percent to about 75 weight percent of the entire adhesive composition.

Examples of polyether polyols include linear and/or branched polyethers having hydroxyl groups. The polyether polyols include polyoxyalkylene polyol such as polyethylene glycol, polypropylene glycol, polybutylene glycol, polyoxypropylene diol, polyoxypropylene triol, polytetrahydrofuran glycol and the like. A homopolymer and a copolymer of the polyoxyalkylene polyols may also be used. In addition, the oligomer polyols may also be used, including polybutadiene glycol, polybutadiene-co-acrylonitrile glycol and the like.

Examples of polyester polyols include unsaturated polyester polyols having at least one ethylenically unsaturated group per molecule and predominantly hydroxyl end groups. The polyester polyol may be prepared from an oligomer of an alpha, beta-ethylenically unsaturated dicarboxylic acid compound obtained by the condensation reaction of one or more of a saturated di- or polycarboxylic acid or anhydride with an excess of glycols or polyhydric alcohols. The unsaturated polyester polyol can also be prepared from unsaturated di- or polycarboxylic acid(s) or anhydride(s) with an excess of glycols and/or polyhydric alcohol(s). Polyester polyols used in the invention may specificly include polyethylene glycol adipate diol, polyethylene-propylene glycol adipate diol, polydiethylene glycol adipate diol, polyethylene-diethylene glycol adipate diol, poly-1,4-butanediol adipate diol, polyneopentylglycol-1,6-hexanediol-adipate diol and the like or the combinations thereof.

A number of suitable polyols are commercially available. Non-limiting examples include polyethers such as ARCOL PPG 2025 (Bayer), PolyG 20-56 (Arch) and Pluracol P-2010 (BASF), polyesters such as Dynacoll 7360 (Degussa), Fomrez 66-32 (Crompton), Rucoflex S-105-30 (Bayer) and Stepanpol PD-56 (Stepan), and polybutadiene such as PolyBD R-45HTLO (Sartomer).

Isocyanates Component

Isocyanate component of the adhesive composition comprises one or more of various suitable polymeric, monomeric or prepolymeric isocyanates. Suitable diisocyanates include ethylene diisocyanate; 1,4-tetramethylene diisocyanate; 1,4 and/or 1,6-hexamethylene diisocyanate; 1,12-dodecane diisocyanate; cyclobutane-1,3-diisocyanate; cyclohexane-1,3- and 1,4-diisocyanate and mixtures of these isomers; 1-isocyanato-3,3,5-trimethyl-5-isocyanatomethyl cyclohexane; 2,4- and 2,6-hexahydrotolylene diisocyanate and mixtures of these isomers; hexahydro-1,3- and/or 1,4-phenylene diisocyanate; perhydro-2,4′- and/or 4,4′-diphenyl methane diisocyanate; 1,3- and 1,4-phenylene diisocyanate; 2,4- and 2,6-toluene diisocyanate and mixtures of these isomers; diphenyl methane-2,4′- and/or 4,4′-diisocyanate; naphthylene-1,5-diisocyanate; 1,3- and 1,4-xylylene diisocyanate, 4,4′-methylene-bis(cyclohexyl isocyanate), 4,4′-isopropyl-bis(cyclohexyl isocyanate), 1,4-cyclohexyl diisocyanate and 3-isocyanatomethyl-3,5,5-trimethylcyclohexyl isocyanate (IPDI); 2,4- and 2,6-toluene diisocyanate; diphenylmethane diisocyanate; hexamethylene diisocyanate; dicyclohexylmethane diisocyanate; isophorone diisocyanate; 1-methyoxy-2,4-phenylene diisocyanate; 1-chlorophenyl-2,4-diisocyanate; p-(1-isocyanatoethyl)-phenyl isocyanate; m-(3-isocyanatobutyl)-phenyl isocyanate and 4-(2-isocyanate-cyclohexyl-methyl)-phenyl isocyanate, isophorone diisocyanate, toluene diisocyanate and mixtures thereof.

It is also possible to use aliphatic or aromatic diisocyanates of the type which are obtained by reacting excess diisocyanate with polyfunctional compounds containing hydroxyl or amine groups and which, in practical polyurethane chemistry, are referred to either as “modified isocyanates” or as “isocyanate prepolymers”. A preferred isocyanate component is an isocyanate prepolymer Vorite 689 derived from castor oil (available from Caschem Company).

Catalyst Component

All-purpose polyurethane catalysts or its modified types are used in the composition of the invention, which include at least one catalyst. The catalyst may comprise from about 0.001 to about 10 weight percent of the adhesive. For the amount of the catalyst component, those skilled in the art may select specifically according to different applied temperature, as well as desired curing speed and adhesive strength. For example, the catalyst which comprises in the range of about 0.001-0.5 weight percent of the adhesive is preferably used when the environmental temperature is in the range of 25-40°; the catalyst which comprises in the range of about 0.5-10 weight percent of the adhesive is preferably used when the environmental temperature is in the range of 5-25° C.

Catalysts used in the invention may include:

1) Tin compounds: such as stannous salts of carboxylic acids, organostannonic acids such as butylstannonic acid, organothiostannonic acids, diorganotin oxides such as dibutyltin oxide, diorganotin sulfides, mono- and diorganotin halides such as dimethyltin dichloride, mono- and diorganotin carboxylates such as dibutyltin dilaurate, dibutyltin adipate and dibutyltin maleate, mono- and diorganotin mercaptides such as dibutyltin bis(lauryl mercaptide), mono- and diorganotin derivatives of mercaptocarboxylic acid esters and mercaptoalkanol esters such as dibutyltin-S,S′-bis(isooctyl mercaptoacetate) and dibutyltin S,S′-bis(mercaptoethyl stearate), diorganotin oxides such as dibutyltin oxide and mono- and diorganotin derivatives of beta-diketones such as dibutyltin bis-acetylacetonate. The preferred catalyst is dibutyltin dilaurate.

2) Organometallic catalysts: some examples of suitable organometallic catalysts include organometallic compounds of iron, bismuth, zirconium, titanate, zinc, cobalt and the like.

3) Amine catalysts: include aliphatic polyamine, polymethylene diamine, aliphatic amine with high carbon number, aliphatic amine with aromatic ring, aromatic amines, cycloaliphatic amine and heterocyclic amine and the like, specifically diethylenetriamine, triethylenetetraamine and its modifier, meta-dimethylphenylene diamine and its modifier, N,N-dimethylaminoethanol, tris(dimethyl aminopropyl) amine, N,N-dimethyicyclohexylamine, bis-(2-methyl aminoethyl) ether, N,N-dimethylbenzylamine, diaminobicyclooctane, triethylamine, tributylamine, N-methylmorpholine, N-ethyl-morpholine, N-coco-morpholine, N,N,N′,N″-tetramethyl-ethylenediamine, 1,4-diaza-bicyclo-(2,2,2)-octane, N-methyl-N′-dimethyl-amino-ethylpiperazine, N,N-dimethylbenzylamine, bis-(N,N-diethyl-aminoethyl)-adipate, N,N-diethylbenzylamine, pentamethyl-diethylenetriamine, N,N-dimethyl-cyclohexylamine, N,N,N′,N′-tetramethyl-1,3-butanediamine, N,N-dimethyl-beta-phenylethylamine, 1,2-dimethyl-imidazole, 2-methy limidazole and mixtures thereof. Also useful are the commercially available tertiary amines such as Niax A-1, available from WITCO; Thancat DD, available from Huntsman; and the like. Mannich bases known per se obtained from secondary amines such as dimethylamine and aldehydes, preferably formaldehyde, or ketones such as acetone, methyl ethyl ketone or cyclohexanone and phenols such as phenol nonylphenol or bisphenol and silaamines having carbon-silicon bonds as described, e.g., in German Patent No. 1,229,290 and U.S. Pat. No. 3,620,984, may also be used as catalysts. Examples include 2,2,4-trimethyl-2-silamorpholine and 1,3-diethylamino-ethyltetramethyl-disiloxane.

Other Additives

Chain extenders may optionally be added to the tri-component adhesive composition of the present invention. These include low molecular weight diols and polyols, such as ethylene glycol, propylene glycol, 1,4-butanediol, 2,3-butanediol, diethylene glycol, hexane diol, trimethyol propane, glycerol, sorbitol, hydroxyl-terminated polyethylene oxide (polyethylene glycol), glycerin and mixtures thereof. Chain extenders may comprise in the range of 0 to about 20 weight percent of the composition.

Optionally, fillers, fibers, plasticizers, pigments, colorants, flame retardants, fungicide, dispersing aids, thixotropic agents, tackifiers or internal lubricants, all of which are well known to those skilled in the art, can be added to the tri-component adhesive composition of the invention. Various organic or inorganic fillers or fibers can be added to reduce the exotherm of the reaction of two components, provide physical reinforcement, and/or reduce its cost. Fillers include such materials as talc, calcium carbonate, silica beads, calcium sulfate, barium sulfate, aluminum trihydrate, ammonium polyphosphate, porcelain clay, etc. The amounts of filler or other additives will vary depending on the desired application.

Illustrative Materials

Illustrative materials used in the invention may be the materials with various forms, as long as they can record the corresponding relationship between the applied temperature of the adhesive and the amount of catalyst used. The forms of the illustrative material include, but are not limited to various recording papers, CD, DVD, tape, video tape and so on.

Preparation of Tri-Component Adhesive

in one embodiment, the tri-component adhesive of the invention is prepared as follow: component A containing one or more polyol resins, including polyester polyols, polyether polyols or the combination thereof, formulated with suitable materials is mixed by dispersion equipments under a certain temperature; component B contains isocyanate curing agents, including TDI and their derivative, MDI and their derivative, or the combinations thereof; Component C containing all-purpose polyurethane curing catalysts, formulated with suitable materials is mixed by dispersion equipments under a certain temperature.

Application of the Tri-Component Adhesive

in one embodiment, the invention provides a method for using the tri-component adhesive under different temperature. The tri-component adhesive comprises a first component containing one or more polyols, a second component containing one or more isocyanates and a third component containing one or more catalysts or their modified catalysts. The method comprises the steps of: keeping the composition of the first component and the second component unchanged; adjusting the amount of a third component according to different temperature, where the amount of the third component is sufficient to achieve desired curing speed and adhesive strength under the corresponding temperature range; and mixing the three components. In general, with the decrease of temperature, the additive amount of the third component will be increased. For example, the third component which comprises in the range of about 0.001-0.5 weight percent is used when the temperature is in the range of 25-40° C.; the third component which comprises in the range of about 0.5-10 weight percent of the adhesive is used when the temperature is in the range of 5-25° C.

In one embodiment, the invention provide a catalyst additive which is used to improve the performance of the adhesive under different temperature. In one aspect, the adhesive is tri-component adhesive, in which a third component comprising the catalyst is added in an efficient amount according to environmental temperature when used. In one aspect, the composition of a first component and a second component remains unchanged. In further aspect, the catalyst is selected from a group consisting of tin compound catalyst, organometallic catalyst, amine catalyst or the combinations thereof, in which the catalyst may comprise in the range of about 0.001 weight percent to about 10 weight percent of the adhesive. In further aspect of this embodiment, the catalyst comprises in the range of about 0.001-0.5 weight percent of the adhesive when the temperature is in the range of 25-40° C.; the catalyst comprises in the range of about 0.5-10 weight percent of the adhesive when the temperature is in the range of 5-25° C.

In one embodiment, the invention provides the use of the tri-component adhesive of the invention in the bonding of wood floor. In one aspect, according to different employed temperature, adding the corresponding amount of the third component of the invention which is sufficient to achieve desired curing speed and adhesive strength under the corresponding temperature; mixing three components; and applying the obtained tri-component adhesive to a substrate. The substrate includes, but is not limited to, various wood, glass, stone, metal sheet, leather and plastic substrate such as PVC and so on. The tri-component adhesive of the invention may also be used in the bonding in any field which the polyurethane adhesive is suitable for.

In another embodiment, the invention provides a method to improve the performance of the adhesive under different temperature by adjusting the amount of catalyst in the adhesive, which including adding an efficient amount of the catalyst according to the applied environmental temperature of the adhesive so that the adhesive has desired performances under the environmental temperature. In one aspect, the adhesive is a tri-component adhesive; the third component comprises the catalyst, added in an efficient amount according to the environmental temperature when used. In one aspect, the composition of the first component and the second component is kept unchanged.

In this embodiment, the catalyst is selected from a group consisting of tin compound catalyst, organometallic catalyst, amine catalyst or the combinations thereof, in which the catalyst may comprise in the range of about 0.001 weight percent to about 10 weight percent of the adhesive.

In one aspect of this embodiment, the catalyst comprises in the range of about 0.001-0.5 weight percent of the adhesive when the environmental temperature is in the range of 25-40° C.; the catalyst comprises in the range of about 0.5-10 weight percent of the adhesive when the environmental temperature is in the range of 5-25° C.

In one embodiment, the invention provides a method to improve conventional two component adhesive, characterized by keeping the composition of the first component and the second component unchanged, adding the catalyst additive as a third component in an efficient amount according to the environmental temperature when used. In further aspect, the catalysts are selected from a group consisting of tin compound catalyst, organometallic catalyst, amine catalyst or the combinations thereof, in which the catalyst may comprise in the range of about 0.001 weight percent to about 10 weight percent of the adhesive. In further aspect of this embodiment, the catalyst comprises in the range of about 0.001-0.5 weight percent of the adhesive when the temperature is in the range of 25-40° C.; the catalyst comprises in the range of about 0.5-10 weight percent of the adhesive when the temperature is in the range of 5-25° C.

In one embodiment, the invention provides an article produced by the use of the tri-component adhesive of the invention.

The invention may be further described by following non-limiting examples.

### EXAMPLES

Shear strength performance test (Refers to GB 7124-1986, Method for Determination of Tensile Lap-Shear Strength of Adhesive, issued by China State Bureau of Standards on Dec. 30, 1986).

Apparatus:

Automatic gas compressor (SMC Cylinder/Press Machine for Woodworking F930G0T), extender (MTS System Corporation/Q-Test VI 50KN Tensile Tester), measuring tool with the accuracy of 1 mm (GUO GEN Tools & Measures Co. ltd, Shanghai, China).

Test Piece:

Beech wood with moisture content of 10±2% and the density of 700±100 Kg/m³ (25×30×10).

Sample Preparation:

The adhesive is spread on the bonding surface. The bonding area is 25 mm×25 mm and the amount of adhesive spread is 100 g/m². Two test pieces are overlap bonded into a sample by automatic sample presser with the pressure of 0.1-0.2 N/mm².

Testing Steps:

1. Measure the length and width of the bonding part of the sample with measuring tools.

2. Place the prepared samples into the clamp with the force parallel each other, start the extender and record the maximum load at the compressed shearing.

Calculation Methods:

1. Calculation of shear strength: δ=P/(L×B)

In which: δ- - - shear strength, Mpa or N/mm²
P - - - maximum load at sample fractured, N
L - - - length of the bonding part of sample, mm
B - - - width of the bonding part of sample, mm

2. Not less than five samples representing the same performance.

### Example 1

### Preparation of a Tri-Component Adhesive 1

According to the following method, different formulations of the tri-component polyurethane adhesive are prepared (See Table 1). To prepare a first component (component A1), polyether polyol 1380BT from Bayor, Germany comprising 60 weight percent of component A1 is poured into a clean stirred tank and the mixture is mixed thoroughly. And then, 39 wt % quartz powders and 1 wt % aids such as deforming agent, are put into the stirred tank respectively with stirring. Followed by adding all components, stirring is continued 60 minutes and the stirred tank is subjected to vacuum and heat. After the content in the stirred tank is up to 110° C., the vacuum is continued 1 hour. Then, the vacuum is stopped, and the content in the stirred tank is discharged, put into another clean container and cooled to room temperature. At this time, component A1 has been prepared for the tri-component adhesive. A second component (component B) is isocyanate prepolymer-MDI. For purpose of these examples, MDI with 19-39% —NCO is used. The preparation of a third component (component C): 90 wt % triethylenetetramines, 5 wt % fungicides and 5 wt % plasticizers are put into a clean stirred tank respectively and this composition is mixed thoroughly. After stirring 30 minutes, the content in the stirred tank is discharged, put into another clean container and stored hermetically.

### Example 2

### Preparation of a Tri-Component Adhesive 2

According to the following method, different formulations of the tri-component polyurethane adhesive are prepared (See Table 2). To prepare a first component (component A2), polyether polyol 1380BT from Bayor, Germany comprising 40 weight percent of component A2 and polyethylene glycol adipate diol (PEA3000) comprising 20 weight percent of component A2 are poured into a clean stirred tank and the mixture is mixed thoroughly. And then, 39 wt % quartz powders and 1 wt % aids such as deforming agent, are put into the stirred tank respectively with stirring. Followed by adding all components, stirring is continued 60 minutes and the stirred tank is subjected to vacuum and heat. After the content in the stirred tank is up to 110° C., the vacuum is continued 1 hour. Then, the vacuum is stopped, and the content in the stirred tank is discharged, put into another clean container and cooled to room temperature. At this time, component A2 has been prepared for tri-component adhesive. A second component (component B) is isocyanate prepolymer-MDI. For purpose of these examples, MDI with 19-39% —NCO is used. The preparation of a third component (component C): 90 wt % triethylenetetramines, 5 wt % fungicides and 5 wt % plasticizers are put into a clean stirred tank respectively and this composition is mixed thoroughly. After stirring 30 minutes, the content in the stirred tank is discharged, put into another clean container and stored hermetically.

### Example 3

### The application of the Tri-Component Adhesive in the Substrate Beech Wood/Beech Wood

The preparations in examples 1 and 2 made using formulations shown in Tables 1 and 2 are respectively used in bonding beech wood/beech wood. Various formulations are mixed under the locale temperature shown in Tables 1 and 2, and spread on the substrates beech wood/beech wood with pressure for a period of time as shown in Tables 1 and 2. The shear strength is determined as described above, the results are shown in Tables 1 and 2.

In the shear strength performance test, the ratio between two components, (A1, component B) and (A2, component B) in the tri-component adhesive is kept unchanged. Before applied on the substrates, three components are ensured to mix thoroughly.

The substrate for tensile shear test by constantly pressing on an automatic press is standard beech wood with length×width×height of 30×25×10 mm³.

The error of locale temperature is not more than 1° C.

The bonding overlapping area is 25×25 mm².

TABLE 1
For example 1, effect of adding different proportions
of component C under different temperature.

| | added proportion (parts by mass) | | | | | | |
|---|---|---|---|---|---|---|---|
| | 1# | 2# | 3# | 4# | 5# | 6# | 7# |
| Added component | | | | | | | |
| component A1 | 80 | 80 | 80 | 80 | 80 | 80 | 80 |
| component B | 20 | 20 | 20 | 20 | 20 | 20 | 20 |
| component C | — | — | 0.5 | 1.50 | 1.50 | 2.00 | 1.50 |
| locale tempera- | 25 | 5 | 20 | 20 | 15 | 10 | 5 |
| ture in | | | | | | | |
| test/° C. | | | | | | | |
| pressing time/h | 2 | 24 | 4 | 4 | 4 | 4 | 6 |

test results

| | | | | | | | |
|---|---|---|---|---|---|---|---|
| shear strength | | | | | | | |
| (beech wood/ | | | | | | | |
| beech wood)/Mpa | | | | | | | |
| strength after 1 hr | | | 0.1 | 1.8 | | | |
| strength after 2 hr | 2.9 | 0.1 | 4.6 | 5.8 | 3.9 | 5.7 | |
| strength after 3 hr | 5 | | 6.8 | 7.2 | 6.4 | 8.9 | 0.4 |
| strength after 6 hr | 8 | | | | | | 5 |
| strength after 24 hr | 13 | 0.8 | 13 | 14 | 15 | 13 | 11 |

TABLE 2
For example 2, effect of adding different proportions
of component C under different temperature.

| | added proportion (parts by mass) | | | | | | |
|---|---|---|---|---|---|---|---|
| | 1# | 2# | 3# | 4# | 5# | 6# | 7# |
| Added component | | | | | | | |
| Component A2 | 80 | 80 | 80 | 80 | 80 | 80 | 80 |
| Component B | 20 | 20 | 20 | 20 | 20 | 20 | 20 |
| Component C | — | — | 0.5 | 1.50 | 1.50 | 2.00 | 1.50 |
| locale temper- | 25 | 5 | 20 | 20 | 15 | 10 | 5 |
| ature in | | | | | | | |
| test/° C. | | | | | | | |
| pressing time/h | 2 | 24 | 4 | 4 | 4 | 4 | 6 |

test results

| | | | | | | | |
|---|---|---|---|---|---|---|---|
| shear strength | | | | | | | |
| (beech wood/ | | | | | | | |
| beech wood)/Mpa | | | | | | | |
| strength after 1 hr | | | 0.1 | 1.7 | | | |
| strength after 2 hr | 2.6 | 0.1 | 4.2 | 5.6 | 3.5 | 5.2 | |
| strength after 3 hr | 4.6 | | 6.3 | 7.2 | 5.8 | 8.1 | 0.4 |
| strength after 6 hr | 7.5 | | | | | | 5.1 |
| strength after 24 hr | 12 | 0.7 | 12 | 13 | 15 | 12 | 11 |

In general, for example, beech wood/beech wood, when the shear strength is up to or more than 5 Mpa, the bonded substrate can meet the requirement of pressure relief and processing. It can be seen from Tables 1 and 2, when the temperature is between 10-20° C., the shear strength (beech wood/beech wood) is all up to or more than 5 Mpa after 3 hours by adding a certain amount of component C, which meet the requirement of most users that the bonded substrate can be pressure relieved and processed after 3 hours. For example, at 20° C., by increasing the amount of component C added, it can be seen that the bonded substrate can meet the requirement of pressure relief and processing after 2 hrs. At lower temperature, such as 5° C., if no component C is added at all, even though after 24 hours, it can not meet user's requirement of pressure relief and processing. However, by adding 1.50% component C, pressing time may be shortened to 6 hours, and after 24 hours, the strength is also close to that at 25° C. The tables illustrate that when keeping the amount of two components A and B added unchanged, adjusting the added amount of a third component, i.e. component C, can well meet the operating requirement between 5-20° C. of users, so as to bring great convenience and feasibility to the operation by users in various areas.

Many modifications and variations of this invention can be made without departing from its sprit and scope, as will be apparent to those skilled in the art. The specific embodiments described herein are offered by way of examples only, and the invention is to be limited only by terms of the appended claims, along with the full scope and equivalents to which such claims are entitled.

1. A tri-component adhesive composition comprising:
a first component containing one or more polyols,
a second component containing one or more isocyanates and
a third component containing one or more catalysts.

2. The tri-component adhesive composition of claim 1, wherein the polyols have a hydroxyl functionality of at least two and molecular weights in the range of about 400 to about 5000.

3. The tri-component adhesive composition of claim 2, wherein the polyols are selected from the group consisting of polyether polyols, polyester polyols, polyolefin polyols, polycarbonate polyols and mixtures thereof.

4. The tri-component adhesive composition of claim 1, wherein the polyols comprise in the range of about 20 weight percent to about 70 weight percent of the entire adhesive composition.

5. The tri-component adhesive composition of claim 1, wherein the isocyanates comprise polymeric isocyanate, monomeric isocyanate, prepolymeric isocyanate and combinations thereof.

6. The tri-component adhesive composition of claim 1, wherein the mole ratio of —NCO group of the isocyanates to —OH group of the polyols is about 0.9 to 1.3.

7. The tri-component adhesive composition of claim 1, wherein the catalysts comprise all-purpose polyurethane catalysts or modified catalysts thereof.

8. The tri-component adhesive composition of claim 1, wherein the third component comprises in the range of about 0.001 weight percent to about 10 weight percent of the adhesive.

9. The tri-component adhesive composition of claim 8, wherein the third component comprises in the range of about 0.001-0.5 weight percent of the adhesive when the environmental temperature is in the range of 25-40° C.; the third component comprises in the range of about 0.5-10 weight percent of the adhesive when the environmental temperature is in the range of 5-25° C.

10. A method for using the tri-component adhesive of of claim 1 under different temperature, comprising the steps of: keeping the composition of the first component and the second component unchanged; adjusting the amount of the third component according to different temperature, which is sufficient to achieve desired performances under the temperature; and mixing the three components.

11. (canceled)

12. An article obtained by applying the tri-component adhesive claim 1 to a substrate.

13. A method to improve the performances of an adhesive under different temperature, comprising adding an efficient amount of a catalyst according to the environmental temperature applied by the adhesive so that the adhesive has desired performances under the environmental temperature.

14. A wood floor bonded by cured reaction products of the tri-component adhesive of claim 1.
